(19) United States
(12) Patent Application Publication
(10) Pub. No.: US 2015/0101674 A1
(43) Pub. Date: Apr. 16, 2015

(54) SUBSEA PRESSURE REGULATOR

(71) Applicant: Hydril USA Distribution, LLC, Houston, TX (US)

(72) Inventor: Ryan Cheaney Gustafson, Houston, TX (US)

(21) Appl. No.: 14/575,361

(22) Filed: Dec. 18, 2014

Related U.S. Application Data
(63) Continuation-in-part of application No. 13/722,698, filed on Dec. 20, 2012, now abandoned.

(51) Int. Cl. E21B 34/04; F16K 17/04; G05D 16/10

(52) U.S. Cl. CPC E21B 34/045; G05D 16/106; F16K 17/0473
USPC 137/14; 137/81.2

(57) ABSTRACT

A pressure regulator having an outlet port, an inlet port, and a vent port, and a regulator piston having an internal passage in constant fluid communication with the outlet port. The regulator piston has a first position where the passage is in fluid communication with the inlet port and not the vent port, a second position where the passage is not in fluid communication with either the inlet port or the vent port, and a third position where the passage is in fluid communication with the vent port and not the inlet port. The pressure regulator also has a spring piston in mechanical communication with the regulator piston that is biased to exert a force on the regulator piston sufficient to move the regulator piston between the first, second, and third positions. The spring piston is enclosed in a spring housing with an internal area maintained at about atmospheric pressure.

### CROSS-REFERENCE TO RELATED APPLICATIONS

This application is a continuation-in-part of U.S. patent application Ser. No. 13/722,698, which was filed Dec. 20, 2012, the full disclosure of which is hereby incorporated herein by reference in its entirety.

### BACKGROUND OF THE INVENTION

1. Field of the Invention

Embodiments disclosed herein relate generally to pressure regulators. In particular, embodiments disclosed herein relate to pressure regulators tuned to external hydrostatic pressure.

2. Brief Description of Related Art

Drilling systems are often employed to access and extract oil, natural gas, and other subterranean resources from the earth. These drilling systems may be located onshore or offshore depending on the location of a desired resource. Further, such systems include a wide array of components, such as valves, that control drilling or extraction operations. Often, some of these components are controlled through pressure variation, such as that provided by a hydraulic control system.

In some such systems, a hydraulic pressure regulator may be used to provide a fluid at a regulated working fluid pressure to downstream components, such as, for example, solenoid valves. One common type of hydraulic pressure regulator has a control piston that moves back and forth to open and close both supply ports and vent ports of the regulator in response to the magnitude of pressure within the regulator. As the functionality of an entire drilling system may depend on proper operation of the hydraulic pressure regulator, it is generally desirable to employ a pressure regulator that is both durable and sensitive to pressure changes. In addition, a subsea pressure regulator that provides a constant pressure output may be beneficial. At greater subsea depths, control of a pressure regulator may become more difficult to maintain.

### SUMMARY OF THE INVENTION

One embodiment of the present invention provides a pressure regulator including a regulator housing having an outlet port, an inlet port, and a vent port, as well as a regulator piston enclosed in the regulator housing and having an internal passage in constant fluid communication with the outlet port, the regulator piston having a first position where the internal passage is in fluid communication with the inlet port and not the vent port, a second position where the internal passage is not in fluid communication with either the inlet port or the vent port, and a third position where the internal passage is in fluid communication with the vent port and not the inlet port. The pressure regulator further includes a spring piston in mechanical communication with the regulator piston that is biased to exert a force on the regulator piston sufficient to maintain the regulator piston in the second position when fluid in the outlet port is at a desired pressure, to allow the regulator piston to move to the first position when the pressure of fluid in the outlet port is lower than the desired pressure, and to allow the regulator piston to move to the third position when the pressure of fluid in the outlet port is higher than the desired pressure. The spring piston further allows pressure regulation by increasing and decreasing flow by restricting the supply or vent port as the internal passage pressure equalizes to the desired set point. In addition, the pressure regulator includes a spring housing attached to the regulator housing and enclosing the spring piston, the area within the spring housing maintained at about atmospheric pressure.

In some embodiments, the outlet port can be exposed to ambient hydrostatic pressure and the vent port can be exposed to ambient hydrostatic pressure. In addition, a biased mechanism can be attached to the spring piston within the spring housing, the biased mechanism providing a resistive force against movement by the spring piston and the regulator piston. Furthermore, a piston mount can be attached to the biased mechanism and the spring housing, the piston mount adjustable in the spring housing to adjust the stiffness of the biased mechanism.

An alternate embodiment of the present invention provides a pressure regulator for regulating pressure acting on BOP components in a subsea environment, the pressure regulator including a regulator housing having an outlet port exposed to ambient hydrostatic pressure when located in the subsea environment, an inlet port for receiving fluid from an external source, and a vent port exposed to ambient hydrostatic pressure, as well as a regulator piston enclosed within the regulator housing, the regulator piston having an internal passage therein in fluid communication with the outlet port, the regulator piston movable so that the internal passage can selectively fluidly communicate with the inlet port to increase the pressure of fluid within the internal passage, the vent port to decrease the pressure of fluid within the internal passage, or neither the inlet port nor the vent port to maintain constant pressure of fluid within the internal passage. The pressure regulator further includes a spring piston in mechanical communication with the regulator piston that limits movement of the regulator piston so that when the pressure of fluid in the outlet port is at a predetermined level, the internal passage is in fluid communication with neither the inlet port nor the vent port.

In some embodiments, the pressure regulator can include a spring housing attached to the regulator housing and enclosing the spring piston, the area within the spring housing maintained at about atmospheric pressure. In addition, the pressure regulator can include a biased mechanism attached to the spring piston within the spring housing, the biased mechanism providing a resistive force against movement by the spring piston and the regulator piston. Furthermore, the pressure regulator can include a piston mount attached to the biased mechanism and the spring housing, the piston mount adjustable in the spring housing to adjust the stiffness of the biased mechanism.

Yet another embodiment of the present technology provides a method of regulating pressure applied to a blow-out preventer (BOP) component. The method includes the steps of exposing the BOP component to the hydrostatic pressure of ambient seawater and fluid pressure within a fluid passage in the regulator piston of the pressure regulator, and adding fluid to the passage in the regulator piston via an inlet port when the fluid pressure exerted on the BOP component is less than a desired pressure level. The method further includes venting fluid from the passage in the regulator piston via a vent port when the fluid pressure exerted on the BOP component is greater than a desired pressure level allowing seawater only to operate the BOP when the ambient pressure is greater than the required BOP operating differential pressure, and controlling movement of the regulator piston using a spring piston attached to the regulator piston and housed in an enclosure having an internal pressure of about 1 atm.

In some embodiments, the method can further include limiting movement of the spring piston and the regulator piston with biased mechanisms attached to the spring piston that damp movement of the spring piston, as well as adjusting the stiffness of the biased mechanism to increase or decrease the amount of force that must be applied to move the regulator piston.

### BRIEF DESCRIPTION OF THE DRAWINGS

The present technology will be better understood on reading the following detailed description of nonlimiting embodiments thereof, and on examining the accompanying drawings, in which:

FIG. 1 shows an isometric view of a pressure regulator in accordance with one embodiment of the present invention;

FIG. 2 shows a side view of a lower BOP stack assembly having the pressure regulator of FIG. 1 attached thereto;

FIG. 3 shows a cross-sectional view, taken along line 1-1, of a pressure regulator in accordance with one embodiment of the present invention;

FIG. 4A shows a cross-sectional view of a pressure regulator in accordance with an embodiment of the invention where the regulator piston is in a first position;

FIG. 4B shows a cross-sectional view of the pressure regulator of FIG. 4A, where the pressure regulator is submerged at a subsea location;

FIG. 5A shows a cross-sectional view of a pressure regulator in accordance with an embodiment of the invention where the regulator piston is in a second position;

FIG. 5B shows a cross-sectional view of the pressure regulator of FIG. 5A, where the pressure regulator is submerged at a subsea location;

FIG. 6A shows a cross-sectional view of a pressure regulator in accordance with an embodiment of the invention where the regulator piston is in a third position;

FIG. 6B shows a cross-sectional view of the pressure regulator of FIG. 6A, where the pressure regulator is submerged at a subsea location.

### DETAILED DESCRIPTION OF THE PREFERRED EMBODIMENT

The foregoing aspects, features, and advantages of the present technology will be further appreciated when considered with reference to the following description of preferred embodiments and accompanying drawings, wherein like reference numerals represent like elements. The following is directed to various exemplary embodiments of the disclosure. The embodiments disclosed should not be interpreted, or otherwise used, as limiting the scope of the disclosure, including the claims. In addition, those having ordinary skill in the art will appreciate that the following description has broad application, and the discussion of any embodiment is meant only to be exemplary of that embodiment, and not intended to suggest that the scope of the disclosure, including the claims, is limited to that embodiment.

In one aspect, embodiments disclosed herein relate to a subsea pressure regulator adjustable in relation to external hydrostatic pressure. In particular, a regulated working fluid pressure of the subsea pressure regulator may be reduced with increasing subsea hydrostatic pressure (i.e., as water depth increases) in order to reduce pressure subsea so as not to exceed the qualifications of a blow-out preventer or other device.

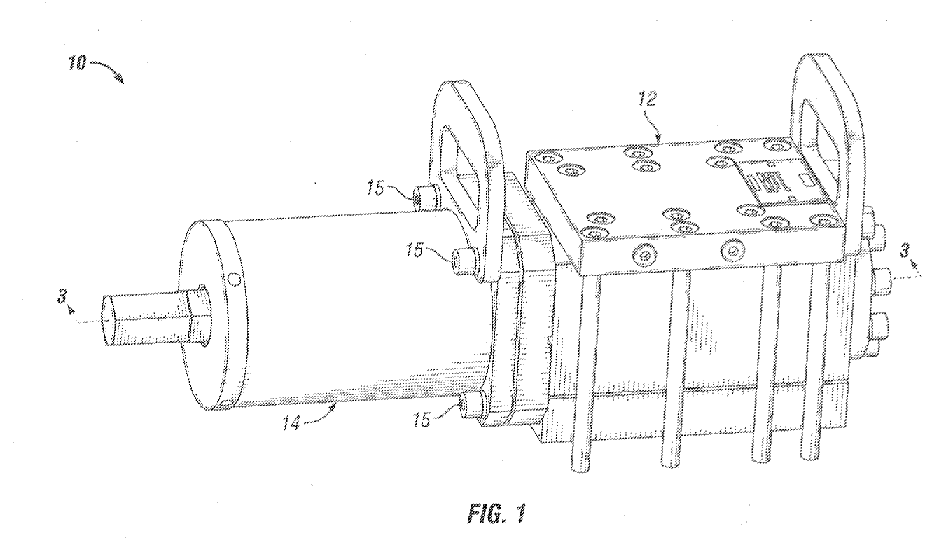

For example, FIG. 1 depicts a pressure regulator 10 according to one example embodiment of the present technology. The pressure regulator 10 includes both a regulator body 12 and a spring housing 14. The regulator body 12 can be attached to the spring housing 14 using an appropriate means, such as, for example, mechanical fasteners 15.

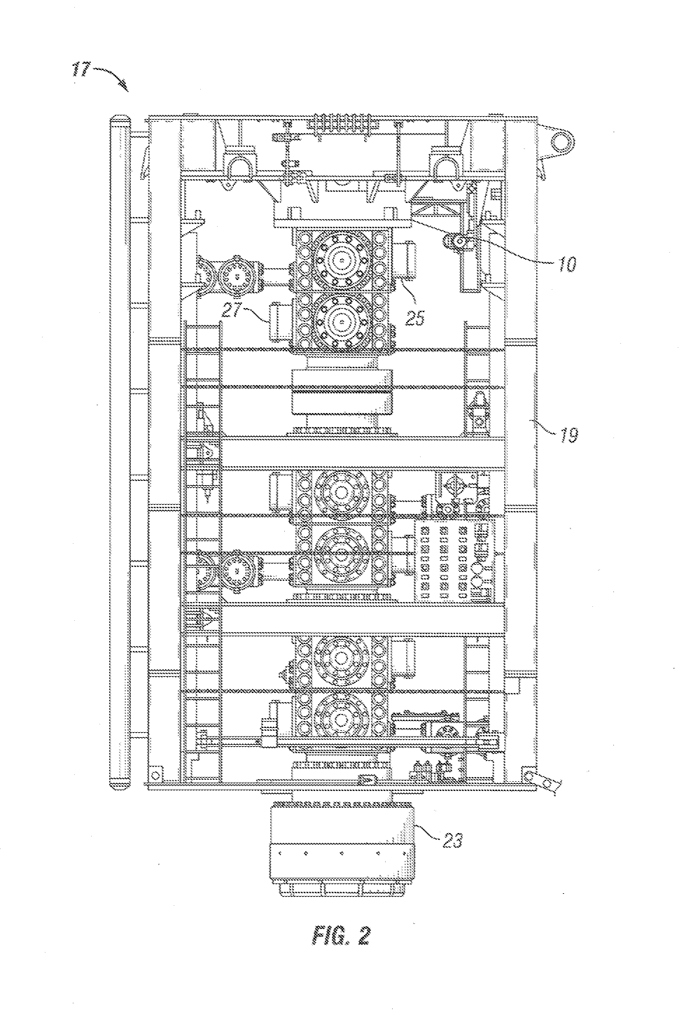

FIG. 2 in turn depicts a lower BOP stack assembly 17, with the pressure regulator 10 attached thereto. The lower BOP stack 17 includes typical BOP features, such as, for example, a frame 19 with a wellhead connector 23 at the lower end for connecting to a subsea wellhead assembly (not shown). Typically, a bore runs through the BOP, including the lower BOP stack assembly 17, which bore may contain a pipe. A shear ram housing 25 is typically located above a pipe ram housing 27 (normal ram configurations are defined as per the drilling operations requirements but normally can be configured with two or three shear rams on the top of the BOP stack with the remaining cavities comprised of various pipe rams). The shear ram housing 25 contains shear ram blocks (not shown) positioned to close across the bore and shear the pipe in an emergency, to seal off the well. The pipe ram housing 27 contains pipe ram blocks (not shown) positioned to close across the bore and seal around the pipe, thereby sealing the annulus around the pipe. In the embodiment shown in FIG. 2, there are multiple sets of ram housings. A lower marine riser package or LMRP (not shown) is positioned and locked on top of the BOP stack. In addition, the LMRP conducts fluid from the surface through the control pods which may also include regulators that supply BOP functions as a primary means of control.

The pressure regulator 10 of the present technology can be hydraulically coupled to the shear and/or pipe ram housings to provide hydraulic pressure to close the shear and/or pipe ram blocks, as explained in greater detail below. The pressure regulator 10 can also be used to hydraulically control other components of the BOP stack, such as, for example, solenoid valves.

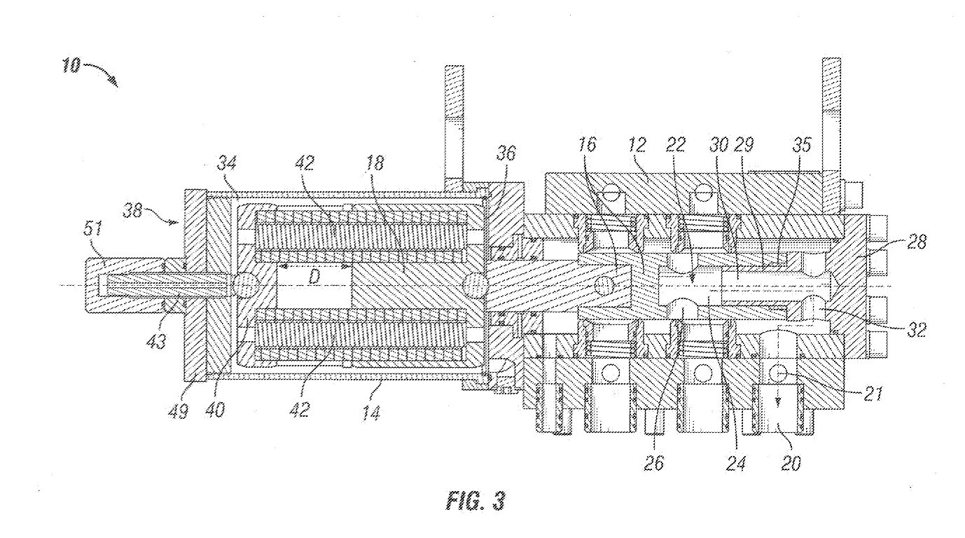

Referring to FIG. 3, a cross-sectional view of a pressure regulator 10 in accordance with one or more embodiments of the present technology is shown. The pressure regulator 10 includes a regulator body 12 coupled with a spring housing 14. A regulator piston 16 is slidably disposed within the regulator body 12, and is engaged with a spring piston 18 in the spring housing 14. The regulator piston 16 is in fluid communication with an outlet 20 of the regulator body 12 via path 21, as shown in FIG. 3. The outlet 20 in turn is in communication with a BOP component (not shown), such as a pair of BOP rams or a valve. One purpose of the pressure regulator 10 is to help maintain a constant pressure at the outlet 20.

The regulator body 12 encloses the regulator piston 16. In FIG. 3, the regulator piston 16 is shown as consisting of two parts, but such a configuration is unnecessary, as the regulator piston 16 could alternately consist of one part or more than two parts. The regulator piston 16 includes an internal passage 22 having a longitudinal piston bore passage 24 and a transverse piston bore passage 26 that intersects the longitudinal piston bore passage 24. The regulator body can also include a regulator cap 28 that attaches to and seals an end of the regulator body 12. The regulator cap has a protrusion 29 that extends into the regulator body 12. The protrusion is hollow and encloses a longitudinal cap bore passage 30 and a transverse cap bore passage 32 that intersects the longitudinal cap bore passage 30. The longitudinal cap bore passage 30 can be coaxial with the longitudinal piston bore passage 24. As shown, the longitudinal piston bore passage 24 is of sufficient diameter to accept insertion of at least a portion of the protrusion 29 so that when the regulator body 12 is fully assembled, the regulator piston 16 surrounds a portion of the protrusion 29. The regulator piston 16 is axially moveable relative to the protrusion 29, and the interface between the regulator piston 16 and the protrusion 29 is guided with a regulator piston bearing 35. The end of the protrusion 29 is open so that fluid is free to flow between the longitudinal piston bore passage 24 and the longitudinal cap bore passage 30.

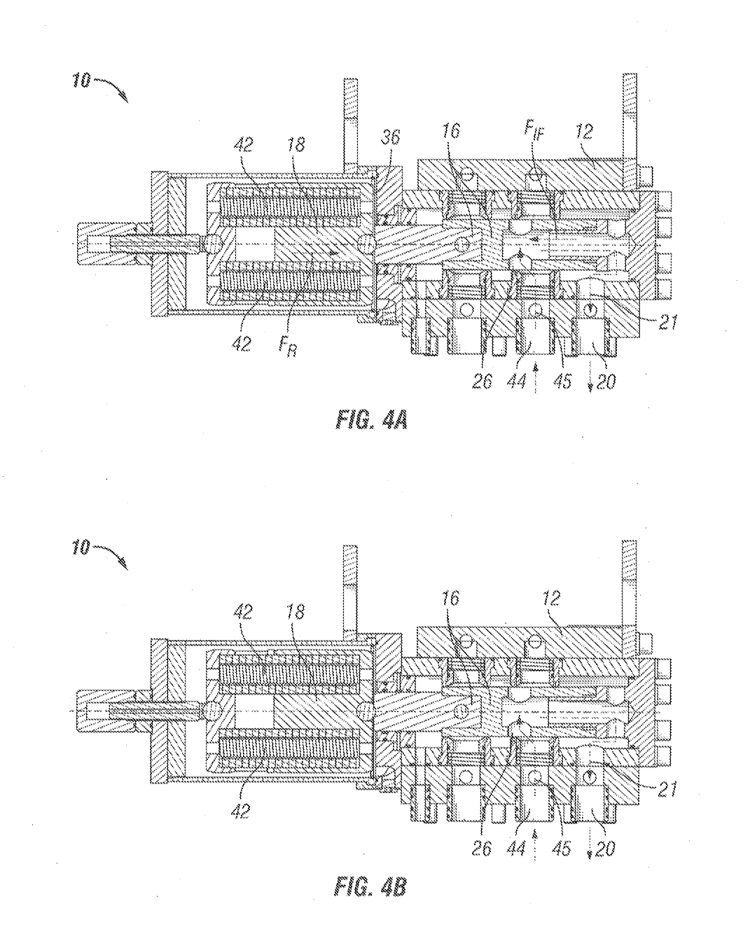

The spring housing 14 encloses an area 34 of low pressure, such as atmospheric pressure. The spring housing 14 includes a first end 36, adjacent the regulator body 12, and a second end 38. The spring housing 14 encloses the spring piston 18 and a piston mount 40. The spring piston 18 is separated from the piston mount 28 by a distance D. The spring housing 14 also encloses biased mechanisms 42 which, in the embodiment shown in FIG. 3, are springs, and which are used to bias the spring piston 18 toward a first position, wherein the spring piston 18 is positioned adjacent the first end 36 of the spring housing 14 (as shown in FIGS. 3-4B). Although the embodiment of FIG. 3 includes two biased mechanisms 42, any number may be used.

Referring still to FIG. 3, the regulator piston 16 is shown in contact with the spring piston 18. In the embodiment shown, a socket and ball are used to centralize the regulator piston 16 and spring piston 18 to allow some misalignment, but other methods may be used. The regulator piston 16 is free to move longitudinally within the regulator housing 12 as dictated by pressure forces (described in detail below). To move toward the spring housing 14, however, the regulator piston must push the spring piston 18 away from the regulator housing 12, which in turn causes the biasing mechanisms 42 to contract and the distance D between the spring piston 18 and the piston mount 40 to decrease. The biased mechanisms 42 act to damp or resist movement of the spring piston 18 and regulator piston 16 toward the piston mount 40.

The position of the piston mount 40 in the spring housing 14 can be fixed during operation of the regulator 10, but can also be adjustable longitudinally along the central axis A of the spring and regulator pistons 18, 16. By moving the position of the piston mount 40 toward or away from the regulator housing 12, the stiffness and associated resistance of the biased mechanisms 42 can be adjusted as desired by a user. For example, in some embodiments, the position of the piston mount 40 can be fixed by an adjustable bolt 43 threadedly engaged with the bottom 49 of the spring housing 14. When the regulator 10 is submerged, the bolt 43 can be protected by a cover 51 that surrounds the bolt 43 and protects the bolt 43 from ambient seawater. To adjust the piston mount 40, the cover 51 is removed, and the bolt 43 can be rotated. As the bolt 43 rotates, the threads of the bolt interact with the corresponding threads on the bottom 49 of the spring housing 14 so that the bolt 43 moves axially toward or away from the first end 36 of the spring housing 14. As it so moves, the end of the bolt 43, which is engaged with the piston mount 40, causes or allows the piston mount 40 to move axially within the spring housing 14 as well, thereby increasing or decreasing tension on the biased mechanisms 42.

The functionality of the regulator 10 will now be described in reference to FIGS. 4A-6B. In the drawings, FIGS. 4A, 5A, and 6A show the regulator 10, including pressures acting on the regulator 10, at the sea surface, without considering ambient seawater pressure. FIGS. 4B, 5B, and 6B show the regulator 10, including pressures acting on the regulator 10, at a depth sufficient to generate an ambient hydrostatic force of about 2,250 pounds per square inch (psi) on the regulator 10.

Referring to FIG. 4A, the regulator piston 16 is shown in a first position. As discussed above, the regulator piston 16 is in fluid communication with an outlet 20 of the regulator body 12 via path 21 regardless of its position within the regulator housing 12. In the first position of FIG. 4A, the transverse piston bore passage 26 is in fluid communication with an inlet 44 via path 45. Typically, the regulator piston 16 is in the first position because the pressure at the outlet 20 is lower than desired. To remedy this deficiency in pressure, a fluid at the inlet 44 can be provided that is at a higher pressure than the desired pressure at the outlet 20.

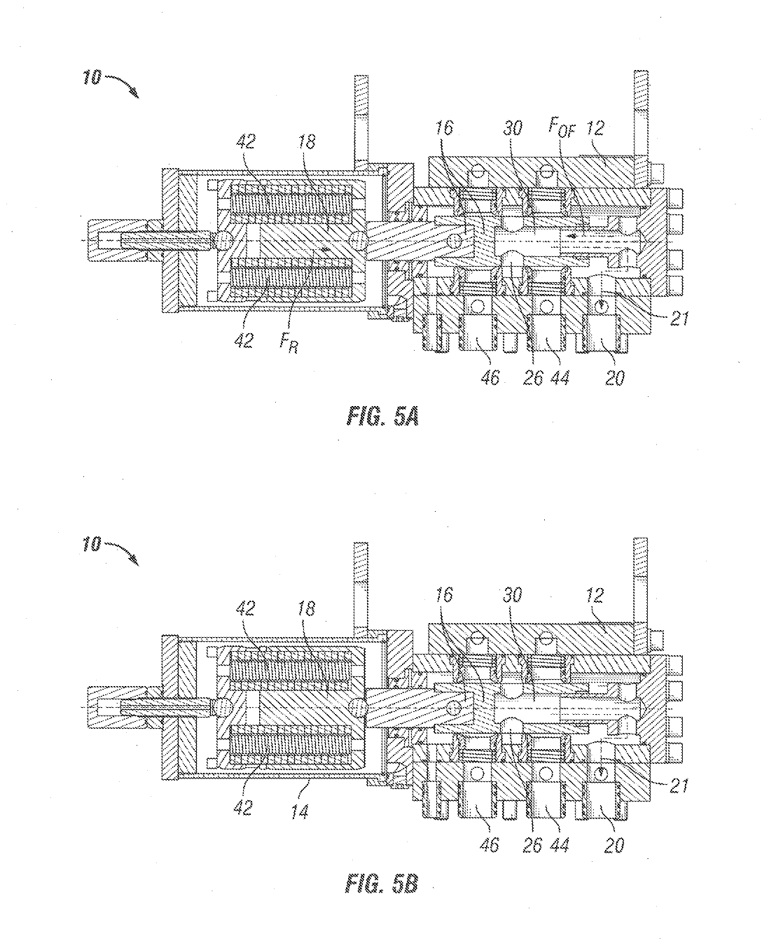

For example, in the example embodiment of FIG. 4A, if the pressure at the outlet 20 is less than 3,000 psi, and an operator desires to raise the pressure at the outlet 20 to 3,000 psi, then a fluid can be provided at the inlet 44 that is higher than 3,000 psi (e.g., 5,000 psi, as shown in FIG. 4A). The higher pressure at the inlet 44 in this embodiment first raises the pressure at the inlet 20, and then pushes the regulator piston 16 out of the first position toward the second position, shown in FIG. 5A. As the regulator piston 16 moves, the biased mechanisms 42 exert a resistive force F_{R} on the regulator piston 16, via spring piston 18, which resistive force F_{R} opposes movement of the regulator piston 12 toward the spring housing 14. Such resistive force F_{R} is less, however, than the inlet fluid force F_{IF} exerted on the regulator piston 16 in the opposite direction by the pressure of the fluid at the inlet 44.

In the second position of FIG. 5A, the regulator piston 16 is in a balanced position. In the second position, the transverse piston bore passage 26 is aligned between the inlet 44 and a vent 46 such that the only fluid path into or out of the longitudinal or transverse piston bore passages 30, 26 is through the outlet 20 via path 21. In the embodiment shown, the second position is achieved when the pressure in the outlet 20 reaches 3,000 psi. When the regulator piston 16 is in position two, the resistance force F_{R} of biased mechanisms 42 and the outlet fluid force F_{OF} are equal, so that the regulator piston 16 does not move axially relative to the regulator housing 12. Of course the target outlet pressure can be adjusted as desired by altering the stiffness of the biased mechanisms 42.

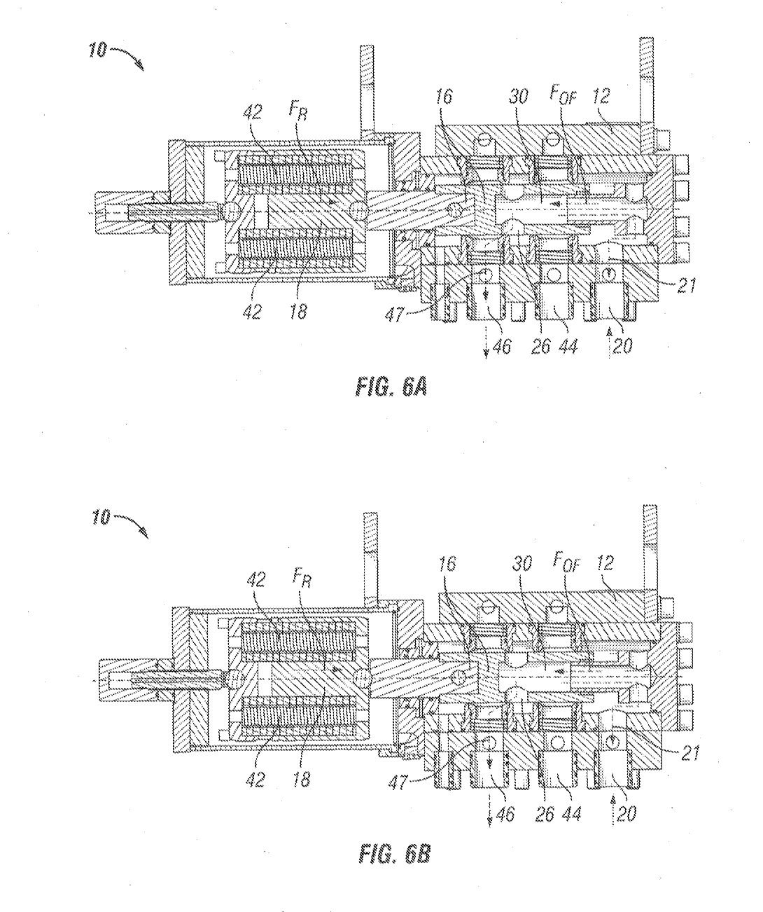

If, however, the pressure of the fluid at the outlet 20 increases, the outlet fluid force F_{OF} becomes greater than the resistive force F_{R} exerted on the regulator piston 16 by the biased mechanisms 42 and spring piston 18. In the embodiment shown, this may occur if the pressure of fluid in the outlet 20 rises above 3,000 psi. In this case, the higher outlet fluid force F_{OF} pushes the regulator piston 16 from the second position to the third position, as shown in FIG. 6A.

In the third position, the outlet fluid force F_{OF} is greater than the resistive force F_{R} of the biased mechanisms 42. This imbalance may be caused, for example, by a rise in the pressure at the outlet 20. In such a situation, the regulator 10 bleeds pressure from the regulator piston 12 by venting fluid from the transverse piston bore passage 26 and out the vent 46 via path 47. As fluid exits the regulator piston 12 via the vent 46, the pressure within the longitudinal and transverse piston bore passages 30, 26 decreases, leading to a corresponding decrease in the outlet fluid force F_{OF}. When the outlet fluid force F_{OF} decreases to the level of the resistive force F_{R} of the biased mechanisms 42, the regulator piston moves from the third position back to the second, or balanced position. Thus, by adding (via inlet 44) or removing (via vent 46) fluids from the internal passage 22 of the regulator piston 12, in combination with exerting an appropriate amount of force on the regulator piston 12 by the spring piston 18 (as driven by the biased mechanisms 42), the pressure of fluid in the outlet 20 can be regulated and maintained substantially constant.

Referring now to FIGS. 4B, 5B, and 6B, there is shown an embodiment of the present technology wherein the regulator 10 is submerged in seawater to a depth wherein the ambient pressure on the regulator is equal to about 2,250 psi. In this embodiment, the regulator functions in the same way as described above with regard to FIGS. 4A, 5A, and 6A. For example, as shown in FIG. 4B, the regulator piston 12 is in a first position due to the fact that the pressure of fluid in the outlet 20 is ambient seawater pressure of 2,250 psi, but the same pressure also acts on area 34 within the subsea compensated spring housing so additional fluid is needed to raise the pressure in the outlet 20 to 3,000 psi because the seawater pressure is balanced and only the biased mechanism 42 exerts a force on the regulator piston 16. In the embodiment shown, the spring housing 14 and associated spring housing components are pressure containing (not compensated) and area 34 maintains atmospheric pressure while on the surface or subsea. When subsea, the ambient seawater pressure of 2,250 psi exerts a force on the biased mechanism 42 creating a larger biased force.

To provide the additional fluid, inlet 44 is open to the transverse piston bore passage 26. The pressure of fluid introduced through inlet 44 is not critical, but should be higher than the pressure desired in the outlet 20. In the embodiment shown, the pressure of fluid provided in the inlet 44 is 5,000 psi, plus 2,250 psi added by the hydrostatic pressure of the ambient seawater. Introduction of the high pressure fluid through the inlet 44 leads to a rise in fluid pressure at the outlet 20 until the desired pressure of 3,000 psi plus 2,250 added by the hydrostatic pressure is reached, at which point the regulator piston 12 moves from the first position shown in FIG. 4B to the second, or balanced position shown in FIG. 5B. Because the pressure of fluid at the outlet 20 may already be as high as 2,250 psi, based on the ambient hydrostatic pressure of the seawater, only 750 psi of additional pressure need be added by way of the inlet 44 to balance the biased mechanism 42 force and force exerted by F_{IF} thus, the effective output pressure of the regulator is reduced with increasing seawater pressure.

If the pressure of fluid at the outlet 20 rises above the desired threshold of 750 psi, the outlet fluid force F_{OF} exerted on the regulator piston 12 pushes the regulator piston toward the spring housing 14 until the transverse piston bore passage 26 opens to the vent 46, thereby allowing fluid to escape, or fill depending on the application, from the regulator piston 12 through the vent 46. Similar to the embodiments described above, as the fluid vents, or fills depending on the application, through the vent 46, pressure within the internal passage 22 of the regulator piston 12 drops or compensates to seawater pressure and, once such pressure reaches the 750 psi threshold, the regulator piston moves from the third position of FIG. 6B back to the second position of FIG. 5B.

Throughout the use of the regulator 10, whether the regulator is in use at the surface or subsea, and regardless of the position of the regulator piston 16 within the regulator housing 12, the area 34 within the spring housing 14, which contains the spring piston 18, the biased mechanisms 42, and the piston mount 40, is at a low pressure, such as atmospheric pressure. There is no need to rely on manually adjusting the biased mechanism 42 to reduce the outlet pressure with increasing water depth. This is advantageous because it ensures that the regulator can be used in a wide range of operations at varying depths without adjustment or modification.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A pressure regulator comprising:
a regulator housing having an outlet port, an inlet port, and a vent port;
a regulator piston enclosed in the regulator housing and having an internal passage in constant fluid communication with the outlet port, the regulator piston having a first position where the internal passage is in fluid communication with the inlet port and not the vent port, a second position where the internal passage is not in fluid communication with either the inlet port or the vent port, and a third position where the internal passage is in fluid communication with the vent port and not the inlet port;
a spring piston in mechanical communication with the regulator piston that is biased to exert a force on the regulator piston sufficient to maintain the regulator piston in the second position when fluid in the outlet port is at a desired pressure, to allow the regulator piston to move to the first position when the pressure of fluid in the outlet port is lower than the desired pressure, and to allow the regulator piston to move to the third position when the pressure of fluid in the outlet port is higher than the desired pressure; and
a spring housing attached to the regulator housing and enclosing the spring piston, the area within the spring housing maintained at about atmospheric pressure.

2. The pressure regulator of claim 1, wherein the outlet port is exposed to ambient hydrostatic pressure and the vent port is exposed to ambient hydrostatic pressure.

3. The pressure regulator of claim 1, further comprising:
a biased mechanism attached to the spring piston within the spring housing, the biased mechanism providing a resistive force against movement by the spring piston and the regulator piston.

4. The pressure regulator of claim 3, further comprising:
a piston mount attached to the biased mechanism and the spring housing, the piston mount adjustable in the spring housing to adjust the stiffness of the biased mechanism.

5. A pressure regulator for regulating pressure acting on BOP components in a subsea environment, the pressure regulator comprising:
a regulator housing having an outlet port exposed to ambient hydrostatic pressure when located in the subsea environment, an inlet port for receiving fluid from an external source, and a vent port exposed to ambient hydrostatic pressure;
a regulator piston enclosed within the regulator housing, the regulator piston having an internal passage therein in fluid communication with the outlet port, the regulator piston movable so that the internal passage can selectively fluidly communicate with the inlet port to increase the pressure of fluid within the internal passage, the vent port to decrease the pressure of fluid within the internal passage, or neither the inlet port nor the vent port to maintain constant the pressure of fluid within the internal passage; and
a spring piston in mechanical communication with the regulator piston that limits movement of the regulator piston so that when the pressure of fluid in the outlet port is at a predetermined level, the internal passage is in fluid communication with neither the inlet port nor the vent port.

6. The pressure regulator of claim 5, further comprising:
a spring housing attached to the regulator housing and enclosing the spring piston, the area within the spring housing maintained at about atmospheric pressure.

7. The pressure regulator of claim 6, further comprising:
a biased mechanism attached to the spring piston within the spring housing, the biased mechanism providing a resistive force against movement by the spring piston and the regulator piston.

8. The pressure regulator of claim 7, further comprising:
a piston mount attached to the biased mechanism and the spring housing, the piston mount adjustable in the spring housing to adjust the stiffness of the biased mechanism.

9. A method of regulating pressure applied to a blow-out preventer (BOP) component, the method comprising:
exposing the BOP component to the hydrostatic pressure of ambient seawater and fluid pressure within a fluid passage in a regulator piston of a pressure regulator;
adding fluid to the passage in the regulator piston via an inlet port when the fluid pressure exerted on the BOP component is less than a desired pressure level;
venting fluid from the passage in the regulator piston via a vent port when the fluid pressure exerted on the BOP component is greater than a desired pressure level; and
controlling movement of the regulator piston using a spring piston attached to the regulator piston and housed in an enclosure having an internal pressure of about 1 atm.

10. The method of claim 9, further comprising:
limiting movement of the spring piston and the regulator piston with biased mechanisms attached to the spring piston that damp movement of the spring piston.

11. The method of claim 9, further comprising:
adjusting the stiffness of the biased mechanism to increase or decrease the amount of force that must be applied to move the regulator piston.
